(19) United States
(12) Patent Application Publication
(10) Pub. No.: US 2004/0177370 A1
(43) Pub. Date: Sep. 9, 2004

(54) Storage and use of viewer preference data in a device remote from a set-top box

(75) Inventor: Gil G. Dudkiewicz, San Francisco, CA (US)

Correspondence Address: FOLEY & LARDNER, 2029 CENTURY PARK EAST, SUITE 3500, LOS ANGELES, CA, 90067

(73) Assignee: MYDTV, INC.

(21) Appl. No.: 10/733,863

(22) Filed: Dec. 10, 2003

Related U.S. Application Data
(60) Provisional application No. 60/432,111, filed on Dec. 10, 2002.

(51) Int. Cl. H04N 5/445; G06F 13/00; H04N 7/10; H04N 7/025; G06F 3/00; H04N 7/173

(52) U.S. Cl. 725/46; 725/34; 725/35; 725/109; 725/110

(57) ABSTRACT

The resources of a remote device such as a head end device are used for storage of viewer preference data. An agent in a set-top box communicates with a server agent at the remote device to transmit viewer preference data from the set-top box to the server, and from the server to the set-top box. The remote device stores viewer preference data for each set-top box associated with the remote device. The remote device also communicates with a web server that hosts a preference modification application. Viewers may modify their viewer preference data through the internet using the preference modification application, and changes to the viewer preference data are communicated from the web server to the remote device and from the remote device to the set top box. Processing of program and segment metadata using the viewer preference data may be performed in the remote device or in the set-top box.

### RELATED APPLICATIONS

This application claims priority from U.S. Provisional Application Serial No. 60/432,111, filed 10 Dec. 2002, the entirety of which is incorporated herein by reference.

This application is related to the subject matter of U.S. Pat. No. 6,651,253, the entirety of which is incorporated herein by reference for its various teachings referenced below.

### BACKGROUND OF THE INVENTION

1. Field of the Invention

Embodiments of the present invention relate to broadcast media systems such as cable and satellite television systems, and in particular to broadcast media systems that provide services to viewers based on data representing the viewer's viewing preferences.

2. Background Technology

Content providers such as cable system operators and satellite television system operators are constantly looking for ways to enhance the viewer's viewing experience. One technology that has been explored is personalization technology that analyzes the content of available programs to identify specific programs that will be of particular interest to particular viewers.

One example of a current personalization technology is described in U.S. Pat. No. 6,651,253. This technology includes several features that enable personalization of the viewing experience. One feature of this technology is metadata generation. Data from production systems that are used to create television programs and other video content is processed to generate metadata describing the subject matter of the programs. The production system data is also parsed to identify information relating to individual segments of programs, and metadata describing the subject matter of the individual segments is also produced. Another aspect of this technology is subject matter categorization. The subject matter of programs and individual program segments is described with reference to a predefined hierarchy of subject matter categories by assigning scores to the categories in the hierarchy in accordance with the degree to which each is descriptive of the subject matter of the program. This enables the description of program subject matter with a high degree of precision using a common subject classification scheme. A further aspect of this technology is viewer preference categorization. Like program content, a viewer's viewing preferences are described by assigning preference scores to categories of the same predefined subject matter category hierarchy. The preference scores indicate the viewer's degree of interest in subject matter described by each category. This enables description of the viewer's interests with a high degree of precision using the same subject matter classification scheme that is used to describe program content. Consequently, another aspect of this technology is identification of programs and program segments of interest to viewers using program and segment metadata and viewer preference data that are both expressed using the predefined subject matter category hierarchy. Correlations between a viewer's viewing preference data and the metadata that describes individual programs are determined to identify programs and program segments that most closely match the viewing preferences of the viewer. This information may then be used to provide a variety of personalization services such as generating alerts for programs that will be of interest to the viewer, automatically scheduling recording of programs of interest to the viewer, and customizing program guide displays to indicate the likely degree of interest to the viewer of each program that is displayed in the guide.

In the technology described above, the analysis of program and segment metadata is typically performed in the viewer's set-top box that receives broadcast signals from a satellite or cable distribution system and produces a video signal for display on a television. In one alternative implementation of the system, the evaluation of program metadata is performed in the system head end and programs are provided to the viewer on a customized basis in accordance with the viewer's interests.

One goal of video distribution technologies is to link the video distribution system with other communications systems typically used by viewers, such as the internet. However, in the personalization technologies described above, the implementation of processing in the set-top box presents an obstacle to such integration, since there is typically no direct way for set-top boxes to communicate through the internet, and the bandwidth available for transmitting data to and from the set-top box is limited and its use is preferably minimized.

Another goal of video distribution technologies is the reduction of the cost of hardware, which can primarily be achieved through minimization of the hardware requirements for the viewer's set-top box. However, personalization services such as those described above can require significant processing resources such as high-speed microprocessors and substantial memory space. Therefore it is desirable to implement personalization technologies in a manner that minimizes the requirements for these costly resources. Implementation of more of the processing load in the head end device is therefore desirable. The head end device implementation described above is one example of such a scheme. However that implementation is primarily intended to provide a video server that transmits only those programs that are determined to be of interest based on viewer preference data.

Therefore there continues to be a need for additional personalization technologies that shift more of the processing and storage burden to the head end, while also providing the viewer with a variety of channels and programming options to choose from.

### SUMMARY OF THE INVENTION

In accordance with embodiments of the invention, the resources of a remote device such as a head end device are used for storage of viewer preference data. A client agent in the set-top box communicates with a server agent at the remote device to transmit viewer preference data from the set-top box to the server, and from the server to the set-top box. The remote device stores viewer preference data for each set-top box associated with the remote device. The head remote also communicates with a web server that hosts a preference modification application. Viewers may modify their viewer preference data through the internet using the preference modification application, and changes to the viewer preference data are communicated from the web server to the remote device and from the remote device to the set top box.

Two preferred embodiments in accordance with the invention are disclosed. In a first preferred embodiment, processing of program and segment metadata is performed in the set-top box. A client in the set-top box communicates with a server at the remote device to send viewer preference data to the server for storage, to obtain stored viewer preference data from the server, and to obtain updated viewer preference data from the server.

In a second preferred embodiment, the processing of metadata is performed in the remote device. In this embodiment, the client in the set-top box serves primarily to send viewer preference data that has been created or modified by the viewer at the set-top box and to maintain the viewer preference data to enable changes to be made by the viewer using the set-top box.

### DESCRIPTION OF THE DRAWINGS

FIG. 1 shows an example of viewer preference data, including category preference scores, keywords, and configuration data;

FIG. 2 shows an example of a portion of a predefined subject matter category hierarchy that may be used to represent the subject matter of programs and segments and the subject matter that a viewer is interested in;

FIG. 3 shows an example of metadata for a program and for a program segment;

FIG. 4 shows hardware, processes and information resources in a system in accordance with an embodiment of the invention;

FIG. 5 shows services provided by processes in a head end device and in a set-top box in accordance with a first preferred embodiment of the invention;

FIG. 6 shows services provided by processes in a head end device and in a set-top box in accordance with a second preferred embodiment of the invention;

FIG. 7 shows a process by which viewer preference data is updated at a set-top box and stored at a remote device;

FIG. 8 shows a process by which a set-top box retrieves viewer preference data from a remote storage device;

FIG. 9 shows a process by which viewer preference data is updated in a remote device in accordance with changes to a category hierarchy and transmitted to a set-top box; and

FIG. 10 shows a process by which viewer preference data is updated through a web server and then transmitted from a remote device to a set-top box.

### DETAILED DESCRIPTION OF PREFERRED EMBODIMENTS

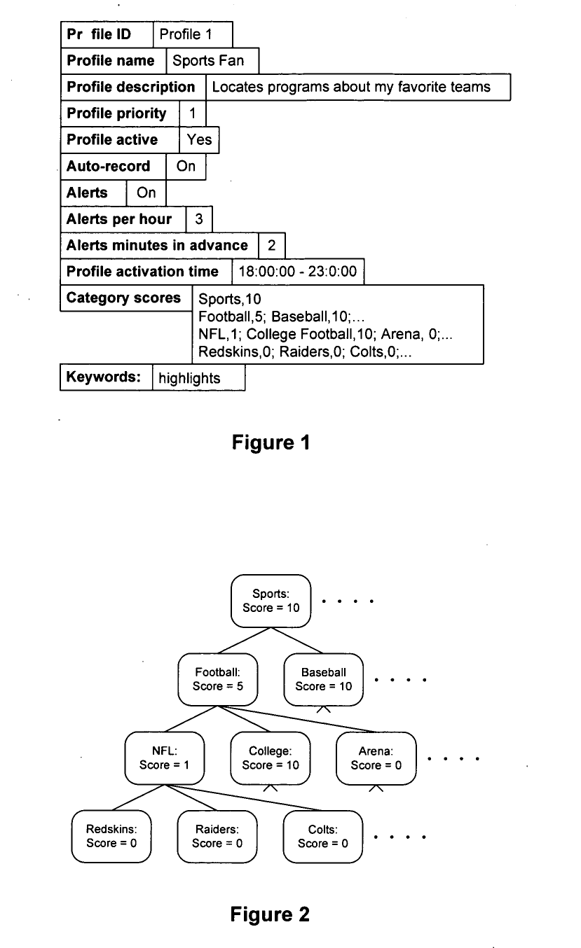

FIG. 1 shows an example of viewer preference data in accordance with preferred embodiments of the present invention. The complete set of viewer preference data, also referred to herein as a viewer profile, comprises data associated with different fields, indicating various information about a viewer's preferences including subject matter preferences and device configuration preferences. A Profile ID field provides a unique identifier for the viewer profile, as there may be more than one viewer profile stored for a given set-top box. A Profile Name field provides a name for the profile as it will be known to viewers. A Profile Description field provides a longer description that may be used to provide more detail about the types of subject matter that the profile is intended to identify. A Profile Priority field holds data that indicates the priority of the profile relative to other profiles associated with the set-top box. A Profile Active field indicates whether the viewer profile is currently being used to identify programs and segments of interest. An Auto-record field indicates whether programs and segments are to be automatically recorded based on the preferences contained in the profile. An Alerts field indicates whether alerts are to be generated for programs and segments based on the preferences contained in the profile. An Alerts Per Hour field provides a number of times per hour that an alert is provided to the viewer indicating that a program or segment having a high correlation to the viewers preferences will be available for viewing. A Profile Alert Minutes In Advance field specifies an amount of time prior to a program or segment that the viewer is to receive an alert. A Profile Activation Time indicates a time of day during which the preferences specified in the profile are to be applied.

A Category Scores field of the viewer profile contains identifiers and associated preference score for categories of a predefined subject matter category hierarchy for which scores have been specified. The preference scores represent the viewer's degree of interest in subject matter described by each category. FIG. 2 shows an example of a portion of a predefined subject matter category hierarchy that corresponds to the viewer preference data of FIG. 1. This manner of representing viewer preferences and the subject matter of programs and program segments is very powerful because it provides a significant amount of detail about the subject matter in a highly structured and consistent manner that enables sophisticated analysis and decision making. While the example provided in FIG. 2 is focused on sports-related subject matter, the categories of the predefined hierarchy will typically include categories that are capable of representing all types of subject matter that are available in television programs, and generally there are multiple top-level categories, examples of which are shown in the patent incorporated herein. In accordance with preferred embodiments of the invention, the predefined hierarchy of subject matter categories includes at least a set of top-level categories, respective sets of first level sub-categories each corresponding to and encompassed by a top level category, and respective sets of second level sub-categories each corresponding to and encompassed by a first level sub-category.

Returning to the viewer profile of FIG. 1, a Keyword List field of the viewer profile contains keywords selected by the viewer to further represent subject matter in which the viewer is interested. Although not shown in FIG. 1, the viewer may associate a keyword with a category of the predefined hierarchy, indicating that the keyword represents the viewer's viewing interests only when associated with subject matter that is also encompassed by the specified category.

In preferred embodiments, the viewer is enabled to create and modify viewer preference data at the set-top box. The set-top box is preferably provided with generic viewer profiles that are tailored to different viewing interests such as sports, politics, news and other common interests. The generic profiles may be pre-programmed in the set-top box or may be provided to the set-top box by the metadata distributor. The user is preferably enabled to modify or delete the generic viewer profiles and to configure additional viewer profiles in accordance with particular viewing preferences.

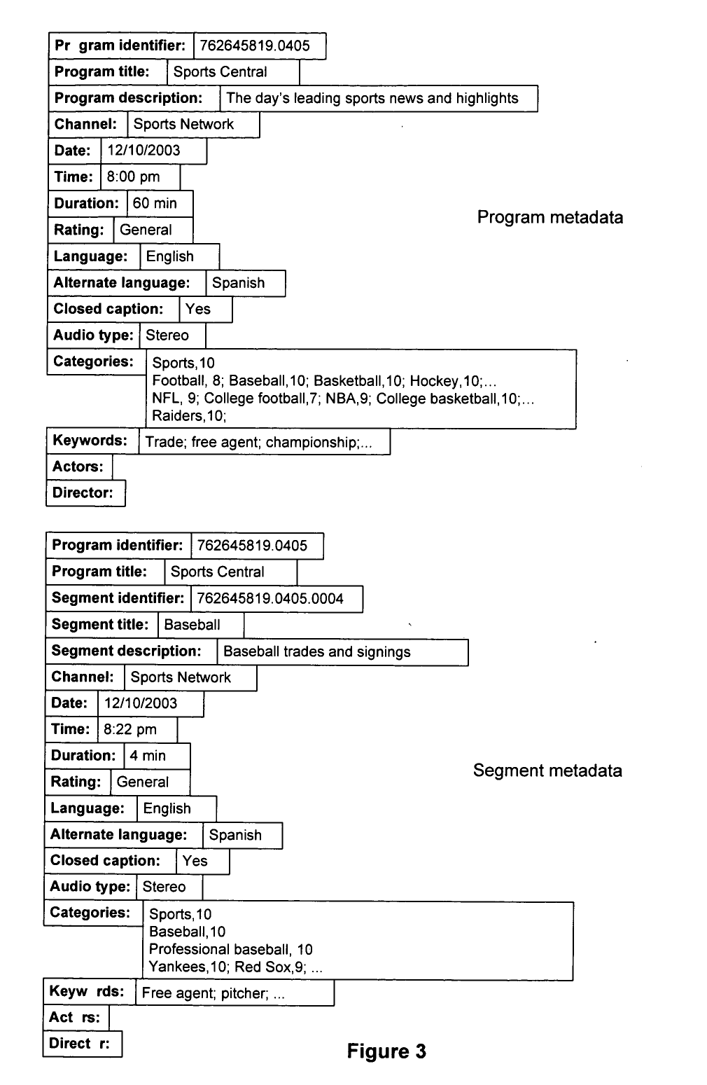

FIG. 3 shows examples of program metadata and segment metadata using a predefined subject matter category hierarchy as described above. The program metadata includes a variety of descriptive information concerning a television program, including the program title, a program description, categories and keywords that are descriptive of the subject matter of the program, and actors and directors associated with the program. Each category included in the metadata is provided with a corresponding score indicating the goodness of fit of the category to the subject matter of the program. The illustrated program metadata further includes timing information such as the start time and duration of the program. Other program information typically included in the program metadata such as a unique program identifier is also illustrated.

The segment metadata of FIG. 3 is similar to the program metadata, but is distinguished from the program metadata in that it provides content and timing information that is specific to an individual segment of a program rather than to the program as a whole. The illustrated segment metadata includes descriptive information including a segment title, a segment description, categories and keywords that are descriptive of the subject matter of the segment, and actors and directors associated with the segment. The illustrated segment metadata further includes timing information such as the start time and duration of the segment. Other segment information typically included in the segment metadata such as a unique segment identifier is also illustrated.

In the preferred embodiment, program metadata and segment metadata are distinct data objects that have logical relationships through the particular data that they contain. For example, the segment metadata of FIG. 3 is related to the program data of FIG. 3 in that they both reference the same program identifier, program title, channel, and date, and the time of the segment is within the time of the program. Thus it is known that the segment metadata of FIG. 3 describes a segment of the program described by the program metadata of FIG. 3. However in alternative implementations other methods may be used to specify relationships between program metadata and segment metadata objects, or metadata objects may be allowed to contain both program metadata and segment metadata.

From the illustrations of FIGS. 1 through 3 it can be seen that the data describing the viewer preferences and the data describing the subject matter of programs and segments a direct and detailed comparison to determine the likely degree of viewer interest in each program and segment for which there is metadata. Specific methods for processing to make this determination are described in the patent incorporated herein.

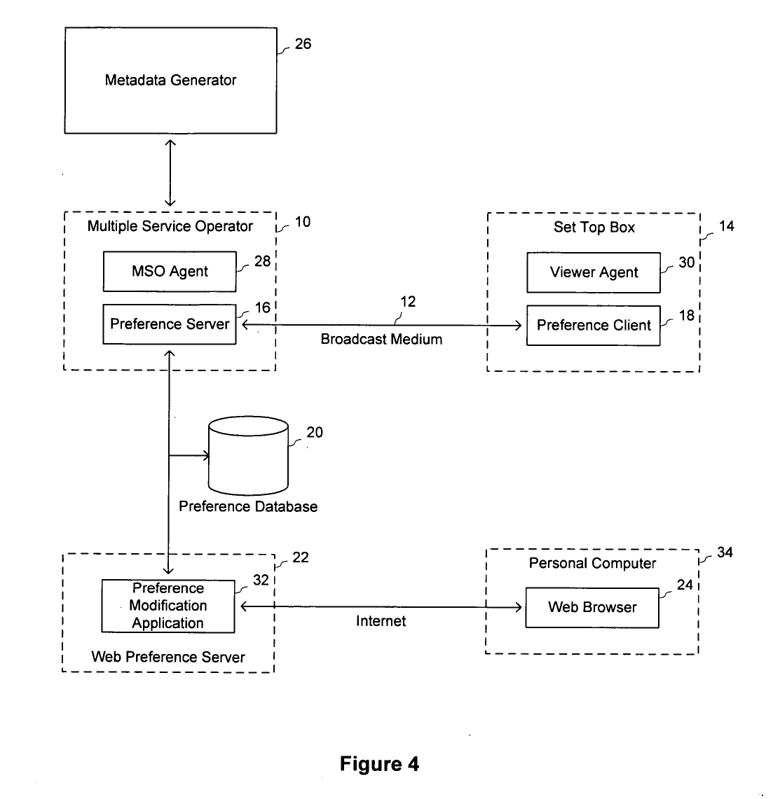

Reference is now made to FIG. 4, which shows a system in accordance with preferred embodiments described herein. In this illustration, physical devices and locations are represented in broken lines, while processes, information resources and communication channels are shown in solid lines.

In the system of FIG. 4, a head end device, referred to herein as a multiple service operator (MSO) 10, communicates through a broadcast medium 12 with a set-top box 14. Depending on the implementation of the system, the broadcast medium may be a cable television distribution system or a satellite television distribution system. The MSO 10 supplies analog or digital video and audio signals to the set-top box, and supplies control signals and data through an out-of-band channel. In various implementations, the data supplied through the out-of-band channel may include program and segment metadata and viewer preference data.

The MSO 10 includes a preference server application 16 that communicates with a preference client 18 in the set-top box to provide for exchange of viewer preference data between the set-top box 14 and the MSO 10. The preference server 16 also communicates with a preference database 20 in which viewer preference data associated with set-top boxes is stored.

The system also includes a web server 22 that hosts a preference modification application 32. The preference modification application 32 allows a viewer to create, modify and delete viewer preference data for the viewer's set-top box 14 by accessing the preference modification application 32 through the internet using the viewer's personal computer 34 and web browser 24. The preference modification application 32 obtains viewer preference data from the preference database 22, enabling it to be displayed to the viewer and modified. The preference modification application 32 also communicates with a preference database 20 to store new and modified viewer preference data. While the illustration of FIG. 4 shows the preference modification application 32 and the preference server 16 both accessing the same preference database 20, alternative implementations of the system may use separate databases respectively associated with the MSO 10 and the web server 22 that are synchronized so as to reflect the same viewer preference data sets.

The MSO 10 also includes an MSO agent 28. The MSO agent 28 receives program and segment metadata from a metadata generator 26. The metadata preferably describes program and segment subject matter using keywords and scores associated with categories of a predefined subject matter category hierarchy as described above. Various other services that may be performed by the MSO agent 30 are described below with respect to the two preferred embodiments.

The set-top box 14 also contains a viewer agent 30. The viewer agent 30 generates a user interface that enables the viewer to create, modify and delete viewer preference data. Various other services that may be performed by the viewer agent 30 are described below with respect to the two preferred embodiments.

In accordance with a first preferred embodiment of the invention, processing of metadata is performed in the set-top box. In accordance with a second preferred embodiment, processing of metadata is performed in the MSO. Details of the operation of the system in accordance with each of these embodiments are now provided.

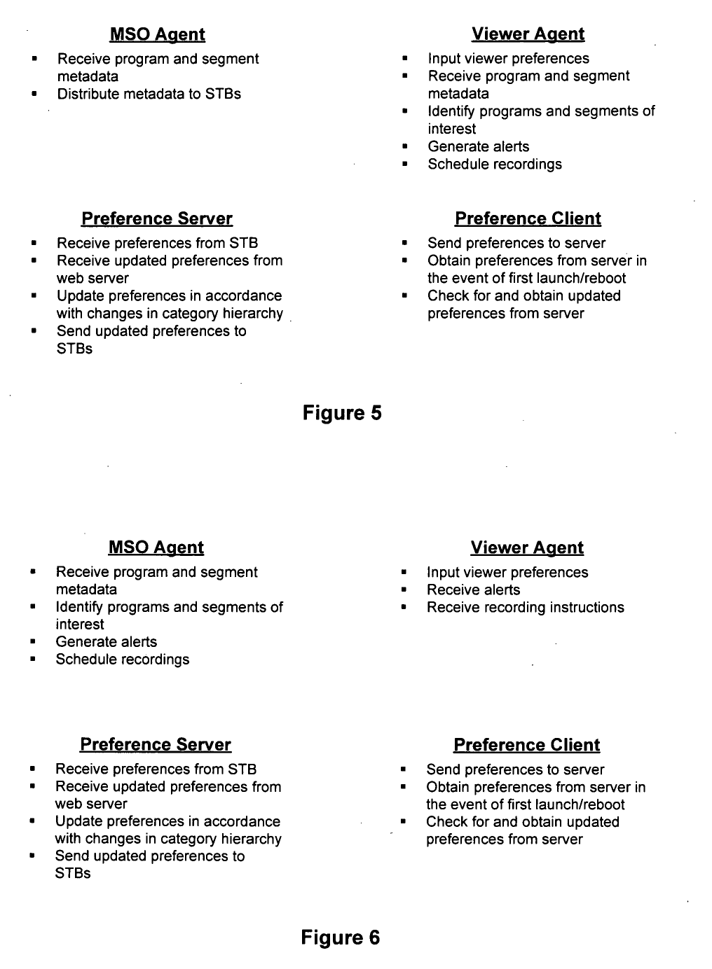

FIG. 5 shows services performed by processes in the MSO 10 and set-top box 14 in accordance with the first preferred embodiment. In this embodiment, the set-top box performs processing using viewer preference data and program and segment metadata to identify programs and segments of interest to the viewer. Accordingly, viewer preference data and metadata are stored at the set-top box 14. In addition, the viewer preference data is stored at the MSO 10, enabling the MSO 10 to serve as backup storage for set-top boxes and to interact with the web server to receive updated viewer preference data and to supply the updated viewer preference data to set-top boxes. As seen in FIG. 5 the MSO agent 28 receives program and segment metadata from the metadata generator 26, and distributes the program and segment metadata to set-top boxes. The viewer agent 30 in the set-top box 14 receives input from the viewer that specifies viewer preferences, receives program and segment metadata from the MSO, and performs processing that identifies programs and segments of interest to the viewer in accordance with the viewer preference data. Based on this identification, the viewer agent 30 may generate alerts to inform the viewer of programs and segments of interest, and, in devices having appropriate storage capabilities, may automatically schedule the recording of such programs and segments.

The preference server 16 of the first preferred embodiment receives viewer preference data that has been generated in the set-top box by the viewer agent 30. This data is stored in the preference database 20. The preference server also sends updated viewer preference data to the set-top box 14. Updated viewer preference data may be generated in two ways. The viewer preference data may be updated by the viewer through the preference modification application on the web server. The updated to preference data is stored by the web server in the MSO preference database or in a local preference database to which the MSO preference database is synchronized. Viewer preference data may also be updated by the preference server 16 in response to input from the metadata generator 26 or another source that indicates a change in the predefined subject matter category hierarchy. For example, a change to the hierarchy that removes a subject matter category may cause the preference server 16 to revise all viewer preference data to remove information relating to that category.

The preference client 18 in the set-top box 14 provides services that are complementary to those of the preference server 16. Upon the creation, modification or deletion of viewer preference data at the set-top box, the preference client 18 transmits the updated viewer preference data to the preference server 16. The preference client 18 also obtains viewer preference data from the preference server 16 in the event of first launch of the set-top box system or in the event of a reboot or memory failure of the set-top box. This enables the set-top box to automatically obtain or re-establish viewer preference data without the need for viewer participation. The preference client 18 also checks for and obtains updated viewer preference data from the preference server. This may be done in a variety of ways. In preferred implementations, the preference server detects the availability of updated viewer preference data such as from web updates and changes to the category hierarchy. The preference server 16 periodically produces a broadcast message that includes the media access controller (MAC) address for each set-top box for which updated viewer preference data is available and transmits the broadcast message to all set-top boxes. These messages are monitored by the preference client in each set-top box, and upon detecting its own MAC address in the broadcast message, the preference client establishes a session with the preference server to obtain the updated viewer preference data. In another implementation, the preference client may periodically contact the preference server to determine whether any updated viewer preference data for the set-top box is available.

FIG. 6 shows services provided by the processes in the MSO 10 and set-top box 14 in accordance with a second preferred embodiment. This embodiment differs from the embodiment of FIG. 5 in that processing to identify programs and segments of interest to the viewer is performed at the MSO. Viewer preference data may be created, modified and deleted by the viewer at the set-top box using the viewer agent 30. The viewer preference data is then transmitted to the MSO 10, where it is stored and processed by the MSO agent 20 to perform services that were performed by the viewer agent in the previous embodiment, such as identifying programs and segments of interest to the viewer, generating alerts for those programs and segments, and automatically scheduling recordings of those programs and segments. The services provided by the preference server 16 and the preference client 18 are essentially the same as in the previous embodiment.

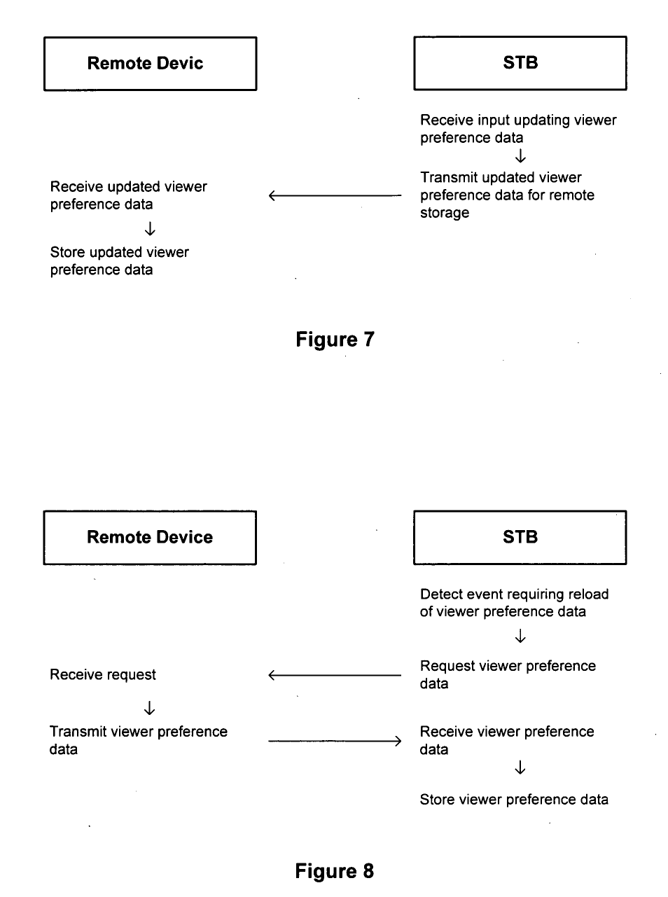

FIGS. 7, 8, 9 and 10 illustrate interactions among processes in a set-top box, a remote device such as a head end device or MSO, and a web server. These interactions are common to the two preferred embodiments and may also be implemented in a variety of alternative embodiments not specifically discussed herein.

FIG. 7 shows a first interaction whereby viewer preference data that is created, modified or deleted at the set-top box is communicated to the remote device for remote storage. Initially the set-top box receives input from a user. The input indicates updates to be made to the viewer preference data. A variety of updates may be made, including: changing the profile name; changing the profile description; changing the profile priority; turning on or off of auto record and alerts features; changing the number of alerts per hour or the amount of advance time for alerts; changing the activation time of the profile; changing, adding or deleting scores associated with categories of the predefined subject matter category hierarchy; or, changing, adding or deleting keywords. Further details of processing for creating or updating viewer preference data are provided in the patent incorporated herein.

Upon completion of the updates to the viewer preference data, the set-top box transmits the updated viewer preference data to the remote device for remote storage. The remote device receives the updated viewer preference data and stores the updated viewer preference data in conjunction with a set-top box identifier as viewer preference data for that set-top box. In accordance with the first preferred embodiment, the set-top box performs processing using the updated viewer preference data, and the remotely stored data serves as a backup. In accordance with the second preferred embodiment, the remote device performs processing using the viewer preference data, and the set-top box uses the viewer preference data for limited purposes such as indicating current preferences to the user for purposes of further updating.

FIG. 8 shows a second interaction whereby viewer preference data is retrieved from the remote device by the set-top box in response to an event such as a reboot, a memory failure or a first launch of the set-top box software. Initially the event is detected by the set-top box, and in response, the set-top box requests viewer preference data from the remote device. Upon receiving the request, the remote device transmits the viewer preference data associated with the set-top box to the set-top box. Upon receiving the viewer preference data, the set-top box stores the viewer preference data and it is thereafter used in processes in the set-top box. In accordance with the first preferred embodiment, the set-top box will perform processing using the updated viewer preference data, and the remotely stored data will serve as a backup. In accordance with the second preferred embodiment, the remote device will perform processing using the updated viewer preference data, and the data received by the set-top box will be used for limited purposes such as indicating current preferences to the user.

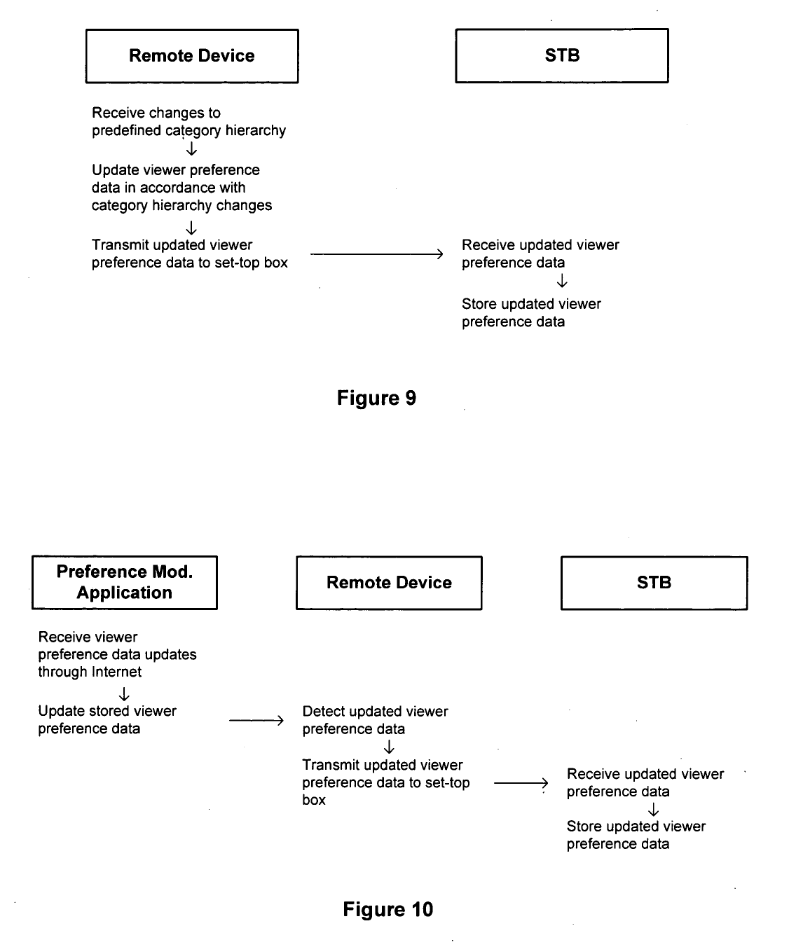

FIG. 9 shows a third interaction whereby changes to the predefined category hierarchy causes viewer preference data to be updated and transmitted to the set-top boxes. Initially the remote device receives information representing changes that have been made to the predefined category hierarchy. These changes may be received from the metadata provider or from some other source. Upon receiving the changes, the remote device updates the viewer preference data stored at the remote device in accordance with the changes to the category hierarchy. This will typically involve deleting categories from the existing viewer preference data. When categories have been relocated in the hierarchy, or when categories have been added, it is not necessary in preferred embodiments to updated the viewer preference data, since the relationship among categories is implicit and will be accounted for in processing of the viewer preferences, and the viewer preference data will not have any scores associated with the new categories. However it is typically necessary to inform the set-top boxes of the changes to the category hierarchy so that further updates and processing are done in conformance with these changes.

After updating the viewer preference data, the viewer preference data is transmitted to the set-top box with which it is associated. This may be accomplished by notifying the set-top box that its viewer preference data has been updated and waiting for a request to transmit the updated viewer preference data, as described above. Upon receiving the updated viewer preference data, the set-top box stores the updated viewer preference data. In accordance with the first preferred embodiment, the set-top box will perform processing using the updated viewer preference data, and the remotely stored data will serve as a backup. In accordance with the second preferred embodiment, the remote device will perform processing using the updated viewer preference data, and the data received by the set-top box will be used for limited purposes such as indicating current preferences to the user.

FIG. 10 shows a fourth interaction whereby viewer preference data is updated through the web server, causing the viewer preference data to be updated subsequently in the remote device and in the set-top box. Initially the preference modification application at the web server receives input indicating updates to be made to the viewer preference data. The preference modification application preferably enables the user to make any updates that can be made directly at the set-top box, such as those described with respect to FIG. 7. The preference modification application then updates the stored viewer preference data. This may involve updated viewer preference data in a local database that is then synchronized with a database at the remote device, or may involve directly updating the database at remote device. Subsequently, upon detection of the updated by the remote device, the updated viewer preference data is transmitted to the set-top box with which it is associated. This transmission may be achieved in the number of ways as described above. Upon receiving the updated viewer preference data, the set-top box stores the updated viewer preference data. In accordance with the first preferred embodiment, the set-top box will perform processing using the updated viewer preference data and remotely stored data will serve as a backup. In accordance with the second preferred embodiment, the remote device will perform processing using the updated viewer preference data, and the data received by the set-top box will be used for limited purposes such as indicating current preferences to the user.

In the aforementioned processes, the transmission of updated viewer preference data may be accomplished either by transmitting the entire set of viewer preference data, or preferably by transmitting only those portions of the viewer preference data that have been changed.

A variety of advantages may be achieved by implementation of the various features described here. The storage of viewer preference data in a head end device or other remote device allows easy replacement of viewer preferences in the event of memory failure at the set-top box. The viewer preference data may be updated remotely in the event of changes to the category hierarchy, thus saving processing resources at the set-top box. With the integration of internet functionality, viewers are also enabled to updated viewer preference data remotely, enabling them to do so without being present at the set-top box.

In accordance with the features of the first preferred embodiment, it also becomes possible to significantly reduce the processing requirements and the set-top box. By performing metadata analysis remotely from the set-top box, processing speed and memory requirements are reduced. In addition, the elimination of the need to transmit metadata to the set-top box for analysis may allow a reduced metadata set to be transmitted, thus saving transmission bandwidth as well as storage space in the set-top box. The first preferred embodiment also enables advanced personalization functions to be provided to customers who have older set-top boxes without a need to upgrade the set-top box hardware.

A variety of additional applications and services may be built on the system for remote storage of viewer preference data described here. The collective store of viewer preference data provides a library of viewer preferences that enables the viewing preferences of the viewing community as a whole to be analyzed and understood. This information may be used for a variety of purposes such as developing generic viewer preferences for new subscribers, and developing new programming in accordance with viewer interests. Further, processing of viewer preference data and metadata at the head end enables alerts to be delivered from the remote device to devices other than the set-top box, such as personal computers, cell phones, personal digital assistants and other network enabled devices. The remotely stored viewer preference data also may be linked to other types of data as such as purchasing histories and other data that is useful in providing additional personalization services such as targeted advertising.

In addition the use of remotely stored viewer preference data enables viewer preferences to be easily portable among different set-top boxes.

While the embodiments and features described herein have been discussed primarily with respect to processes and methods it will be appreciated that the invention may further be embodied in programmable hardware devices that include computer readable media storing programming code for controlling the devices to perform processing as discussed above. The invention may be further embodied in systems comprising multiple devices performing respective processing tasks to achieve the performance of services as described herein.

The devices, features and processing described herein are not exclusive of other devices, features and processing, and variations and additions may be implemented in accordance with the particular objectives to be achieved. For example, a system as described above may be integrated with other systems not described herein to provide further combinations of features, to operate concurrently on the same computing devices, or to serve other types of users. Thus, while the embodiments illustrated in the figures and described above are presently preferred for various reasons as described herein, it should be understood that these embodiments are offered by way of example only. The invention is not limited to a particular embodiment, but extends to various modifications, combinations, and permutations that fall within the scope of the claims and their equivalents.

What is claimed is:

1. A method in a video distribution system, comprising:
creating, at a set-top box, viewer preference data representing subject matter of interest to the viewer;
transmitting the viewer preference data from the set-top box to a remote device;
receiving updates to the viewer preference data at a web server; and
updating the viewer preference data at the remote device in accordance with the updates received at the web server.

2. The method claimed in claim 1, wherein the remote device is provided at a head end device of the video distribution system.

3. The method claimed in claim 1, wherein the remote device is provided at a multiple service operator device of the video distribution system.

4. The method claimed in claim 1, further comprising transmitting the updated viewer preference data from the remote device to the set-top box.

5. The method claimed in claim 4, further comprising:
transmitting metadata describing the subject matter of video programs to the set-top box; and
performing processing in the set-top box to determine video programs of interest to the viewer using the metadata and the viewer preference data.

6. The method claimed in claim 5, further comprising providing alerts to the viewer for programs determined to be of interest to the viewer.

7. The method claimed in claim 5, further comprising automatically recording programs determined to be of interest to the viewer.

8. The method claimed in claim 5, wherein the metadata further comprises metadata describing the subject matter of segments of video programs; and
wherein said processing determines video programs and segments of video programs of interest to the viewer.

9. The method claimed in claim 4, wherein transmitting the updated viewer preference data to the set-top box is preceded by:
detecting the updated viewer preference data for the set-top box at the remote device;
transmitting a broadcast message from the remote device that includes the media access controller (MAC) address of the set-top box in the message; and
receiving in response to the broadcast message a request from the set-top box to transmit the updated viewer preference data.

10. The method claimed in claim 1, further comprising:
receiving metadata describing the subject matter of video programs at the remote device; and
performing processing at the remote device to determine video programs of interest to the viewer using the metadata and the viewer preference data.

11. The method claimed in claim 10, further comprising transmitting alerts to the set-top box for programs determined to be of interest to the viewer.

12. The method claimed in claim 10, further comprising transmitting instructions to the set-top box to automatically record programs determined to be of interest to the viewer.

13. The method claimed in claim 10, wherein the metadata further comprises metadata describing the subject matter of segments of video programs: and
wherein said processing determines video programs and segments of video programs of interest to the viewer.

14. A method in a video distribution system, comprising:
receiving input from a user at a set-top box representing viewer preferences;
storing viewer preference data representing the viewer preferences in the set-top box;
transmitting the viewer preference data to a remote device; and
storing the viewer preference data at the remote device.

15. The method claimed in claim 14, further comprising:
receiving input from the user at the set-top box updating the viewer preferences; and
transmitting updated viewer preference data to the remote device for storage at the remote device.

16. The method claimed in claim 14, wherein the viewer preference data represents viewer preferences for subject matter corresponding to categories of a predefined the subject matter category hierarchy.

17. A method in a video distribution system, comprising:
detecting, at a set-top box, an event requiring reload of viewer preference data at the set-top box;
transmitting a request for the viewer preference data from the set-top box to a remote device;
transmitting viewer preference data associated with the set-top box from the remote device to the set-top box in response to the request; and
receiving and storing the viewer preference data at the set-top box.

18. The method claimed in claim 17, wherein the event is a set-top box reboot.

19. The method claimed in claim 17, wherein the event is a set-top box memory failure.

20. The method claimed in claim 17, wherein the event is a first launch of set-top box software.

21. The method claimed in claim 17, wherein the viewer preference data represents viewer preferences for subject matter corresponding to categories of a predefined the subject matter category hierarchy.

22. A method in a video distribution system, comprising:
storing viewer preference data associated with a set-top box in a database associated with a device that is remote from the set-top box;
updating the viewer preference data in the remote device in accordance with changes to a predefined subject matter category hierarchy used to represent viewer subject matter preferences in the viewer preference data; and
transmitting the updated viewer preference data to its associated set-top box from the remote device.

23. The method claimed in claim 22, wherein transmitting the updated viewer preference data to the set-top box is preceded by:
transmitting a broadcast message from the remote device that includes the media access controller (MAC) address of the set-top box in the message; and
receiving in response to the broadcast message a request from the set-top box to transmit the current viewer preference data.

24. The method claimed in claim 22, further comprising:
detecting updates made to the viewer preference data at a web server; and
updating the viewer preference data in a database in accordance with the updates made at the web server.

25. The method claimed in claim 22, wherein the remote device is a head end device of the video distribution system.

26. The method claimed in claim 22, wherein the remote device is a multiple service operator device of the video distribution system.
